(19) United States
(12) Patent Application Publication
(10) Pub. No.: US 2025/0296458 A1
(43) Pub. Date: Sep. 25, 2025

(54) System for charging a vehicle battery

(71) Applicant: AVL Software and Functions GmbH, Regensburg (DE)

(72) Inventor: Mathias DEIML, Regensburg (DE)

(73) Assignee: AVL Software and Functions GmbH, Regensburg (DE)

(21) Appl. No.: 19/076,425

(22) Filed: Mar. 11, 2025

(30) Foreign Application Priority Data
Mar. 21, 2024 (DE) 102024108162.7
May 17, 2024 (DE) 102024113906.4

(51) Int. Cl. B60L 53/22; H02J 7/02

(52) U.S. Cl. CPC B60L 53/22; H02J 7/02; B60L 2220/16; H02J 2207/20

(57) ABSTRACT

Disclosed is a device for fast charging a battery, with two inverter circuits, which are each electrically connected to a three-phase electric motor, the battery being electrically connected on the one hand to an inverter plus and on the other hand to an inverter minus of the inverter circuits, and with a charging voltage connection, the positive terminal of which can be connected to a multi-way switch, and the negative terminal of which can be connected to the inverter negative of both inverter circuits or to a further multi-way switch, wherein the inverter positive of the two inverter circuits can be electrically connected via the one multi-way switch, at least one inductor of one electric motor can be electrically connected, and via one multi-way switch or via the other multi-way switch at least one inductor of the other electric motor can be electrically connected.

The invention relates to the technical field of power electronics and in particular to the fast charging of a battery according to claim 1, preferably an automotive battery according to claim 9.

An electric vehicle uses electrical energy as its main energy source. Accordingly, the electric vehicle essentially requires a high-voltage battery for storing electrical energy, at least one motor and at least one inverter for converting the electrical energy into kinetic energy. In order to increase the efficiency of the electric vehicle's drive, batteries with a high voltage are preferably used. Fast and efficient charging of such batteries is necessary.

However, if an electric vehicle is to be charged with a battery voltage of 800 V at a charging station, the output voltage of the charging station can be 500 V or 800 V. The battery can be charged directly with a charging voltage of 800 V. A charging voltage of 500 V must be increased using a suitable voltage booster/boost converter. This is usually realised by a voltage booster installed in addition to the inverter and the electric motors.

It would be desirable to realise fast charging of a battery in a simpler and more cost-effective way.

Accordingly, the present invention provides a device for fast charging a battery, having two inverter circuits which are each electrically connected to a three-phase electric motor, the battery being electrically connected on the one hand to an inverter plus and on the other hand to an inverter minus of the inverter circuits, and having a charging voltage connection whose positive terminal can be connected to a multi-way switch and whose negative terminal can be connected to the inverter minus of both inverter circuits or to a further multi-way switch, and whose negative terminal can be connected to the inverter negative of both inverter circuits or to a further multi-way switch, wherein the inverter positive of the two inverter circuits can be electrically connected via the one multi-way switch, and at least one inductor of the one electric motor can be electrically connected, and at least one inductor of the other electric motor can be electrically connected via the one multi-way switch or via the further multi-way switch.

A key point here is to boost (increase) the charging voltage from 500 V to 800 V without having to install an additional voltage booster. Only the components already installed in an electric car (inverter and electric motors) are used to boost the charging voltage. In particular, the charging current in the proposed circuit must flow through a small number of switches and diodes, so that the electrical losses are significantly reduced.

Advantageous further embodiments of the method according to the invention are given in the subclaims.

In a first advantageous embodiment, it is therefore provided that a charging voltage connection plus and a charging voltage connection minus can be electrically connected to separate multi-way switches, of which an inductor of one electric motor and an inverter plus can be electrically connected via one multi-way switch, and an inductor of the other electric motor and an inverter minus can be electrically connected via the other multi-way switch. This makes the multi-way switches simpler and more cost-effective.

In a second advantageous embodiment, it is provided that the multi-way switch comprises three diodes or switches via which the respective inverter circuits and the respective inductors of the electric motors can be electrically connected, which enables a simple and cost-effective provision of a multi-way switch. The switches can also be designed as transistors, IGBT (insulated-gate bipolar transistor) power semiconductors or as contactors. With this circuit, charging is possible at 500 V and 800 V charging voltage.

In a further advantageous embodiment, it is provided that, in a charging operation of 800 V or 500 V, the multi-way switch comprises two diodes or switches that can be electrically connected to the inverter plus of a respective inverter circuit via switches of the inverter circuit, resulting in a particularly simple and cost-effective design of the device.

In a further advantageous embodiment, it is provided that respective capacitors electrically, preferably electrically switchably, connect the inverter plus of the inverters and a node of the multi-way switch and/or the inverter minus of the inverters and the node of the multi-way switch to each other. This can be used in particular to smooth the input and output voltages of the inverters/inverters.

In another advantageous embodiment, additional inductors are provided in the input path of a charging current, thereby increasing the total value of the inductors in the current paths of the inverters. It is preferable that the additional inductors are provided upstream or downstream of the multi-way switch in the current direction. It is particularly preferable that only a single inductor is inserted upstream of the multi-way switch.

In principle, the device can be used for fast charging a battery in any type of electric drive system. Preferably, however, it should be used for fast charging an automotive battery, in particular an automotive battery of an electric vehicle.

Further advantages, objectives and features of the present invention are explained with reference to the following description of the attached figures. Similar components may have the same reference signs in the various embodiments.

It shows:

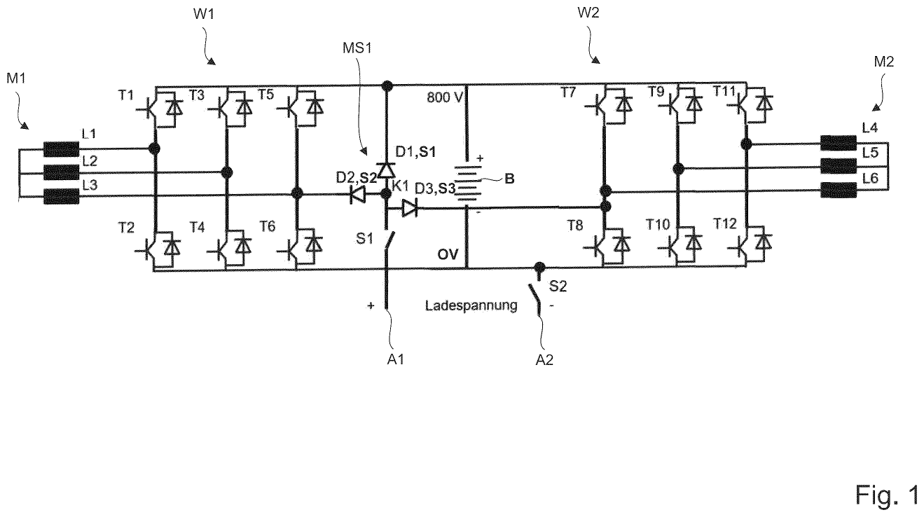

FIG. 1 a circuit diagram of a device according to the invention for fast charging a battery;

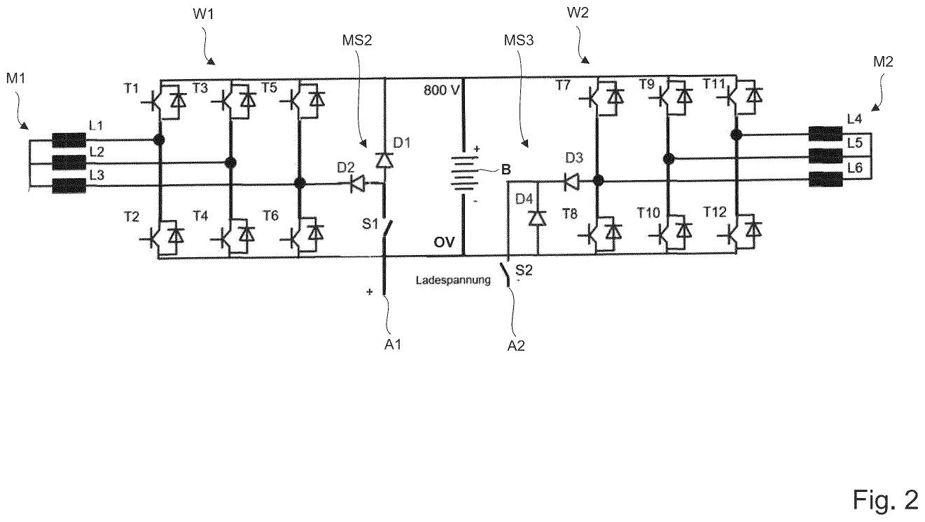

FIG. 2 an alternative circuit diagram of a device according to the invention for fast charging a battery;

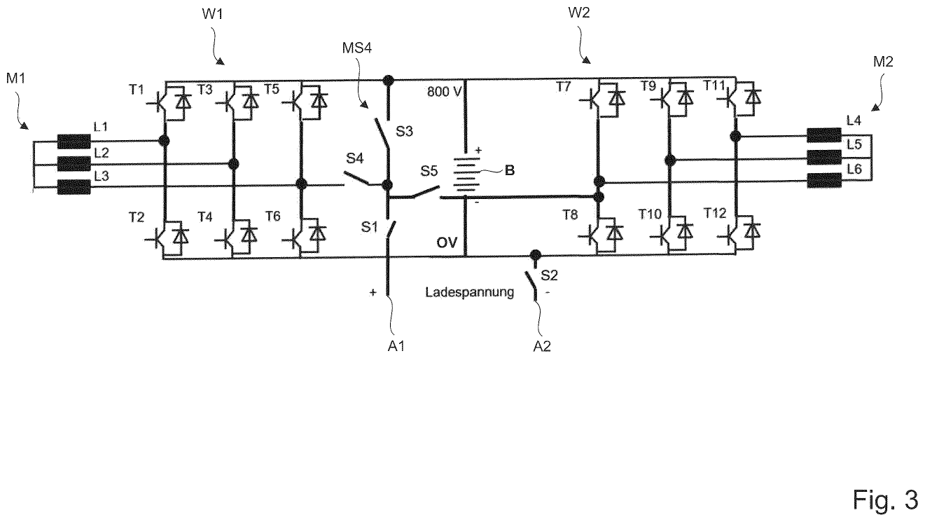

FIG. 3 the circuit diagram of FIG. 1 with a multi-way switch in which the diodes are replaced by switches;

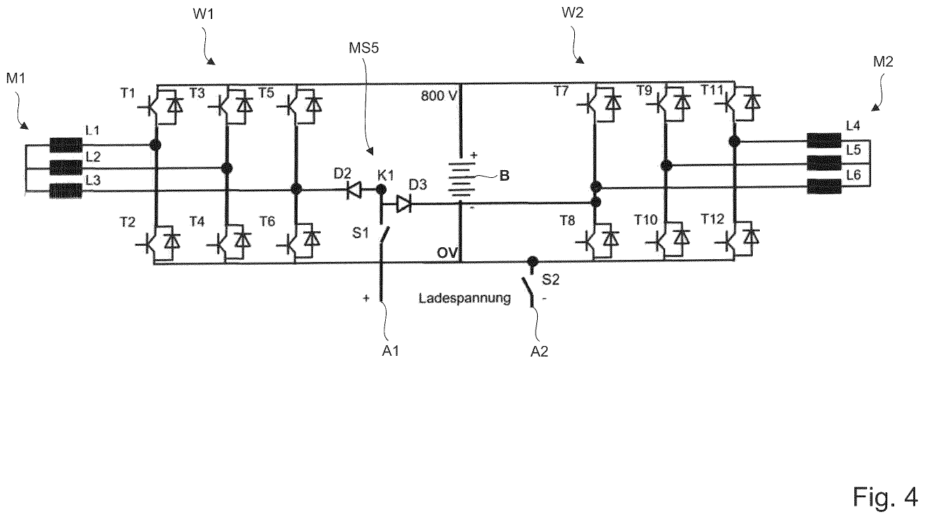

FIG. 4 the circuit diagram of FIG. 1 with a multi-way switch, with only two instead of three diodes;

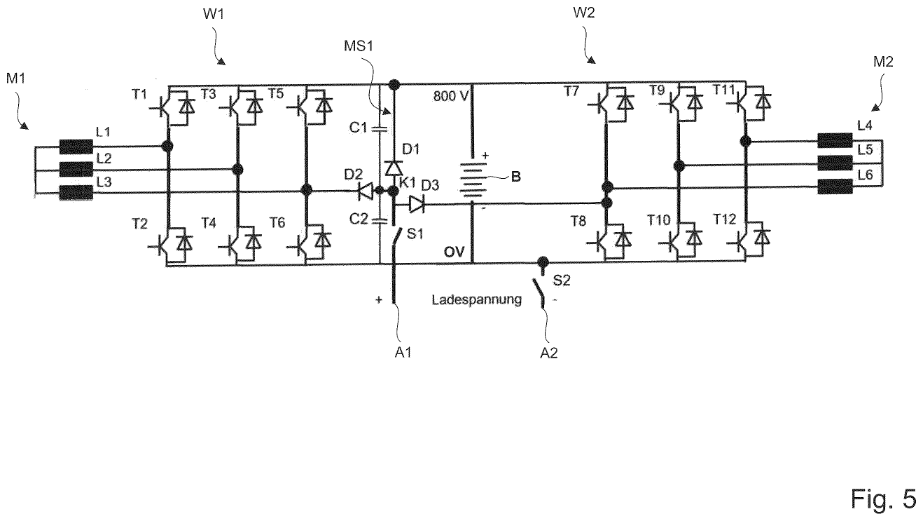

FIG. 5 the circuit diagram of FIG. 1 with additional capacitors;

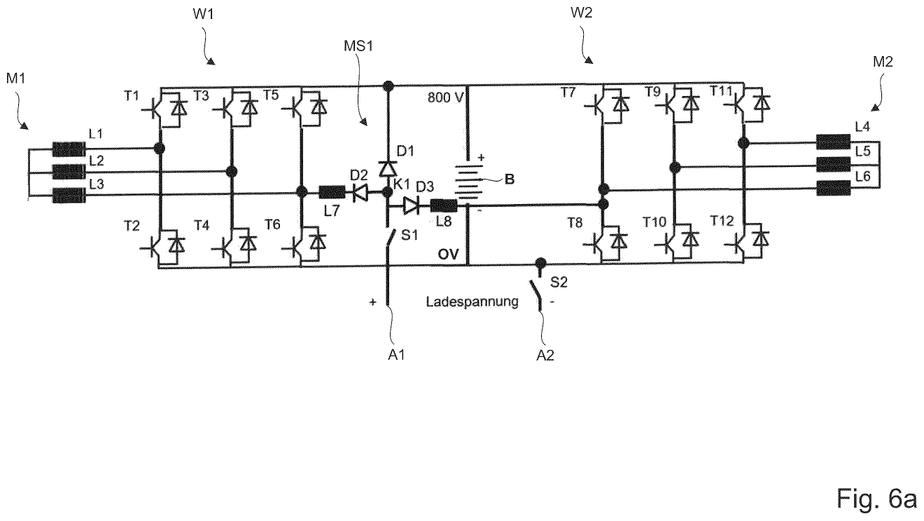

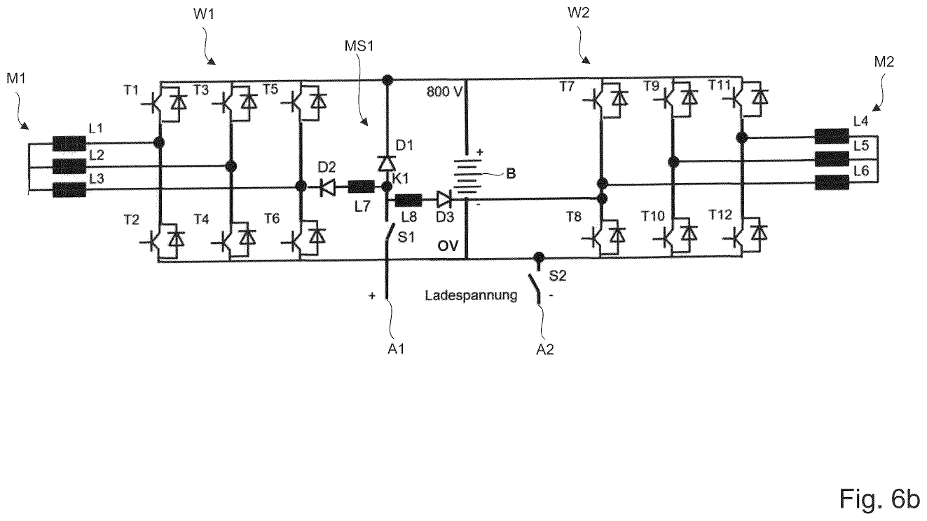

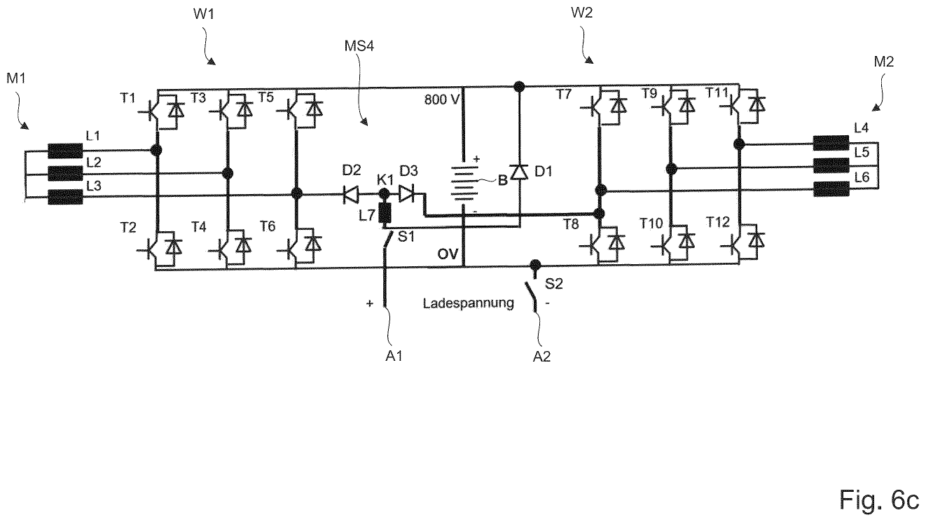

FIG. 6a the circuit diagram of FIG. 1 with additional inductors, in the direction of current behind the multi-way switch;

FIG. 6b the circuit diagram of FIG. 1 with additional inductors, in the direction of current before the multi-way switch, and

FIG. 6c the circuit diagram of FIG. 4 with additional inductors, in the direction of current before the multi-way switch.

FIG. 1 shows a circuit diagram of a device according to the invention for fast charging a battery B. In this case, an electric car has at least two drives, each consisting of an inverter W1, W2 and an electric motor M1, M2.

In this circuit, the power is not fed in via a motor neutral point-as in other developments-but via a phase of the electric motors M1, M2. This has the advantage that the motor neutral point does not have to be led out. According to the invention, the current flows from a charging station via a phase of the electric motors M1, M2 to the neutral point of the respective electric motors M1, M2. Starting from the neutral point of the electric motors M1, M2, the current flows via 2 phases and clocked half-bridges of the inverter W1, W2 to the battery B. The motor inductances L1 . . . L6 are advantageously used as boost chokes.

The inverter W1 comprises half bridges with switching elements T1 to T6, which can be controlled via a control device. The switching elements are preferably transistors. Preferably, the switching elements T1 to T6 are IGBT (insulated-gate bipolar transistor) power semiconductors or SIC (silicon carbide) MOSFETS (meta-oxide semiconductor field-effect transistor). However, other suitable controllable switching elements are also conceivable. The motor inductance L1 is connected to the half bridge comprising the switching elements T1 and T2. The motor inductance L2 is connected to the half bridge comprising the switching elements T3 and T4. The motor inductance L3 is connected to the half bridge comprising the switching elements T5 and T6. The same applies to the inverter W2.

To realise the boost function, a multi-way switch MS1 with diodes D1, D2 and D3 is installed between the inverters W1, W2. Switches S1 and S2, which switch the charging voltage connections A1, A2 for the external power supply, are used to ensure safe disconnection of the charging contacts during operation.

In charging mode (at 500 V or 800 V), switches S1 and S2 are closed. They are open in driving mode. In driving mode, diodes D1 . . . D3 have no effect on the inverters W1, W2. In charging mode with a charging voltage of 800 V, diode D1 becomes conductive and the charging current can charge battery B via switch S1 and diode D1 as well as switch S2.

In charging mode with a charging voltage of 500 V, diode D1 blocks. To boost the charging voltage, the charging current in the left inverter/inverter W1 is routed via diode D2, inductor L3 and inductors L1/L2. The switches T1 . . . T4 boost the charging voltage to 800 V. Switches T5 and T6 are disabled. In the right-hand inverter W2, the current is conducted via diode D3 and inductors L6, L5/L4. The switches T9 . . . T12 boost the voltage to 800 V. Switches T7 and T8 are disabled.

The advantage here is the lower number of switches required. In addition, with a charging voltage of 800 V, the charging current only has to flow via diode D1, which significantly reduces losses.

FIG. 2 shows an alternative circuit diagram of a device according to the invention for fast charging a battery B, which provides that a charging voltage PLUS is connected via S1 to diodes D1 and D2 of a multi-way switch MS2. Charging voltage MINUS is connected via switch S2 to diodes D3 and D4 of a multi-way switch MS3.

In charging mode (at 500 V or 800 V), switches S1 and S2 are closed. They are open in driving mode. In charging mode with a charging voltage of 800 V, diodes D1 and D4 become conductive, allowing the charging current to charge battery B via S1 and D1 on the one hand and S2 and D4 on the other.

In charging mode with a charging voltage of 500 V, diodes D1 and D4 block. To boost the charging voltage, the charging current in the left inverter/inverter W1 is routed via diode D2, inductor L3 and inductors L1/L2. The switches T1 . . . T4 are activated. The switches T5 and T6 are disabled. In the right-hand inverter W2, the current is conducted via diode D3 and inductors L6, L5/L4. The switches T9 . . . T12 are activated. Switches T7 and T8 are disabled. By suitable activation of switches T1 . . . T4 and T9 . . . T12, the input voltage is boosted to 800 V.

In principle, the left-hand side of the device with battery B, multi-way switch MS2, inverter W1 and motor M1 could also be used as a fast-charging device for boosting a charging voltage from 500 V to 800 V.

FIG. 3 shows the circuit diagram of FIG. 1 with a multi-way switch MS4, in which the diodes D1 . . . D3 have been replaced by switches S3 . . . S5, which allows a more targeted control of the switches S3 . . . S5.

FIG. 4 shows the circuit diagram of FIG. 1 with a multi-way switch MS5, with only two instead of three diodes D2, D3. This circuit is thus constructed without a third diode D1, whereby the current in charging mode is conducted at a voltage of 800 V via diode D2 and switch T5 on the one hand, and via diode D3 and switch T7 on the other. With this circuit, charging is possible at 500 V and 800 V charging voltage. The difference to the circuit in FIG. 1 is that when charging at 800 V, the charging current flows via more components such as diode D2 and switch T5 or diode D3 and switch T7. However, the advantage is that there is no need for diode D1, whereby charging with a charging voltage of 500 V works in exactly the same way as in the circuit in FIG. 1, resulting in a particularly simple and cost-effective multi-way switch MS5.

FIG. 5 shows the circuit diagram of FIG. 1 with additional capacitors C1, C2. These are connected to node K1 to smooth the input and output voltage of the booster circuits. The capacitors C1, C2 can be connected directly to the node K1 or connected in a switchable manner via a switch.

FIG. 6a shows the circuit diagram of FIG. 1 with additional inductors L7, L8, in the current direction downstream of the multi-way switch MS5. Additional inductors in the input path of the charging current can increase the total value of the inductors of the two booster circuits. The additional inductors L7 and L8 can be inserted either between the node K1 and D2 and D3 or between the centre tap of the half bridges and D2 and D3. FIG. 6b shows the circuit diagram of FIG. 1 with additional inductors, in the direction of current before the multi-way switch MS1.

FIG. 6c shows the circuit diagram of FIG. 4 with an additional single inductor L7, in the direction of current before the multi-way switch MS4. This is inserted between the anode of diode D2 and diode D3 and node K1. Diode D1 is connected between node K1 and a battery PLUS.

Overall, the device according to the invention for fast charging a battery thus results in a simple and flexible charging system that is also cost-effective and particularly suitable for electric vehicles, which can easily utilise voltages of 500 V or 800 V.

### LIST OF REFERENCE SIGNS

B Battery
C1, C2 Capacitors
MS1 . . . MS5 Multi-way switch
K1 Node
L1 . . . L8 Inductors
M1, M2 Electric motors
A1, A2 Charging voltage connection
S1 . . . S5 Switches
T1 . . . T12 Switches
W1, W2 Inverter circuits/inverters

1. Device for fast charging of a battery,
having two inverter circuits which are each electrically connected to a three-phase electric motor, the battery being electrically connected on the one hand to an inverter plus and on the other hand to an inverter minus of the inverter circuits, and having a charging voltage connection, whose positive terminal can be connected to a multi-way switch, and whose negative terminal can be connected to the inverter negative of both inverter circuits or to a further multi-way switch,
wherein the inverter positive of the two inverter circuits can be electrically connected via the one multi-way switch, and at least one inductor of one electric motor can be electrically connected, and at least one inductor of the other electric motor can be electrically connected via one multi-way switch or via the other multi-way switch.

2. Device according to claim 1,
wherein:
a charging voltage connection plus and a charging voltage connection minus can be electrically connected to separate multi-way switches, of which an inductor of one electric motor and an inverter positive can be electrically connected via one multi-way switch, and an inductor of the other electric motor and an inverter negative can be electrically connected via the other multi-way switch.

3. Device according to claim 1,
wherein:
the one multi-way switch comprises three diodes or switches, via which the respective inverter circuits and the respective inductors of the electric motors can be electrically connected.

4. Device according to claim 1,
wherein:
for a charging operation of 800 V or 500 V, the one multi-way switch comprises two diodes, which can be electrically connected via switches of a respective inverter circuit to its inverter plus.

5. Device according to claim 1,
wherein:
respective capacitors electrically connect the inverter plus of the inverters and a node of the one multi-way switch and/or the inverter minus of the inverters and the node of the one multi-way switch to one another.

6. Device according to claim 5,
wherein:
the respective capacitors electrically switchably connect the inverter plus of the inverters and the node of the one multi-way switch and/or the inverter minus of the inverters and the node of the one multi-way switch to one another.

7. Device according to claim 1,
wherein:
additional inductors are provided in the input path of a charging current.

8. Device according to claim 7,
wherein:
the additional inductors are provided upstream or downstream of the one multi-way switch in the direction of current.

9. Device according to claim 7, wherein a single additional inductor is provided in the direction of current upstream of the one multi-way switch.

10. Use of a device according to claim 1 for fast charging an automotive battery, in particular the automotive battery of an electric vehicle.
